(19) United States
(12) Patent Application Publication
(10) Pub. No.: US 2025/0028146 A1
(43) Pub. Date: Jan. 23, 2025

(54) OPTICAL ELEMENT DRIVING MECHANISM

(71) Applicant: TDK TAIWAN CORP., Taoyuan City (TW)

(72) Inventors: Ying-Jen WANG, Taoyuan City (TW); Yi-Ho CHEN, Taoyuan City (TW); Ya-Hsiu WU, Taoyuan City (TW)

(21) Appl. No.: 18/777,923

(22) Filed: Jul. 19, 2024

Related U.S. Application Data
(60) Provisional application No. 63/514,958, filed on Jul. 21, 2023.

(51) Int. Cl. G02B 7/08; G02B 27/64

(52) U.S. Cl. CPC G02B 7/08; G02B 27/646

(57) ABSTRACT

An optical element driving mechanism is provided. The optical element driving mechanism includes a first movable portion, a fixed portion and a first driving component. The first movable portion is configured to connect a first optical element. The fixed portion has a main axis. The first movable portion is movable relative to the fixed portion. The first driving component is configured to drive the first movable portion to move relative to the fixed portion.

### CROSS REFERENCE TO RELATED APPLICATIONS

This application claims the benefit of U.S. Provisional Application No. 63/514,958, filed Jul. 21, 2023, the entirety of which is incorporated by reference herein.

### BACKGROUND OF THE INVENTION

### Field of the Invention

The present invention relates to an optical element driving mechanism, and in particular, it relates to an optical element driving mechanism with a driving component.

### Description of the Related Art

With the advancement of technology, many electronic devices today (such as smartphones) have photo-taking or video-recording capabilities. The use of these electronic devices is becoming increasingly widespread, and they are being developed to be more convenient and miniaturized design, to provide users with more options.

The aforementioned electronic devices with photo-taking or video-recording capabilities usually have an optical element driving mechanism, where light can pass through optical elements (such as shutter blades, filters, lenses, etc.) to form an image on the image sensor. The current trend in mobile devices is miniaturization and weight reduction, so how to effectively miniaturize the optical element driving mechanism has become an important issue.

### BRIEF SUMMARY OF THE INVENTION

The present disclosure provides an optical element driving mechanism. The optical element driving mechanism includes a first movable portion, a fixed portion and a first driving component. The first movable portion is configured to connect a first optical element. The fixed portion has a main axis. The first movable portion is movable relative to the fixed portion. The first driving component is configured to drive the first movable portion to move relative to the fixed portion.

According to some embodiments of the present disclosure, when viewed along the main axis, the geometric center of the fixed portion does not overlap with the geometric center of the first optical element. The first optical element has a polygonal structure when viewed along the main axis. When viewed along the main axis, the geometric center of the first movable portion does not overlap with the geometric center of the first optical element.

### BRIEF DESCRIPTION OF THE DRAWINGS

Embodiments of the present disclosure will be described in detail below with reference to the accompanying drawings. It should be noted that, according to standard industry practices, various features are not drawn to scale and are for illustrative purposes only. In fact, the dimensions of the elements may be arbitrarily enlarged or reduced in order to clearly illustrate the features of the present disclosure.

FIG. 1 is a perspective view of an optical element driving mechanism according to some embodiments of the present disclosure.

FIG. 2 is an exploded view of the optical element driving mechanism according to some embodiments of the present disclosure.

FIG. 3 is a perspective view of the optical element driving mechanism without showing the housing.

FIG. 4 is a perspective view of a part of a first circuit member according to some embodiments of the disclosure.

FIG. 5 is a perspective view of a part of the optical element driving mechanism according to some embodiments of the disclosure.

FIG. 6 shows a partial cross-sectional view of the optical element driving mechanism taken along line A-A′ of FIG. 1.

FIG. 7 shows an exploded schematic view of a first optical element corresponding to the opening of the first circuit member.

FIG. 8 shows a bottom view of the optical element driving mechanism according to some embodiments of the present disclosure.

FIG. 9 is a cross-sectional view of the optical element driving mechanism taken along line B-B′ in FIG. 1.

FIG. 10 shows a top view of part of the optical element driving mechanism according to some embodiments of the present disclosure.

FIG. 11 is a cross-sectional view of the optical element driving mechanism taken along line C-C′ in FIG. 1.

FIG. 12A shows a schematic side view of a second driving portion and a corresponding element according to one embodiment of the present disclosure.

FIG. 12B shows a schematic side view of the second driving portion and the corresponding element according to another embodiment of the present disclosure.

FIG. 13 shows a block diagram of the optical element driving mechanism according to some embodiments of the present disclosure.

FIG. 14 is a perspective view of the optical element driving mechanism according to another embodiment of the present disclosure.

### DETAILED DESCRIPTION OF THE INVENTION

Unless otherwise defined, all terms, including technical and scientific terms, used herein have the same meaning as commonly understood by one of ordinary skill in the art to which this disclosure belongs. It is understood that these terms, such as terms defined in commonly used dictionaries, should be interpreted to have a meaning consistent with the background or context of the relevant technology and the present invention, and should not be interpreted in an idealized or overly formal manner, unless otherwise defined herein.

Furthermore, ordinal numbers such as “first,” “second,” etc., used in this specification and claims to modify elements of the claims, do not inherently imply or represent any chronological order of the claimed elements, nor do they signify any sequence between one claimed element and another, or the order of manufacturing methods. The use of such numbers is solely to distinguish one claimed element with a certain name from another claimed element with the same name.

Additionally, in some embodiments of the present invention, terms related to joining or connecting, such as “connect,” “interconnect,” etc., unless specifically defined, can refer to two structures being in direct contact or not in direct contact, with other structures placed between them. Furthermore, these terms related to joining or connecting can include scenarios where both structures are movable or both structures are fixed.

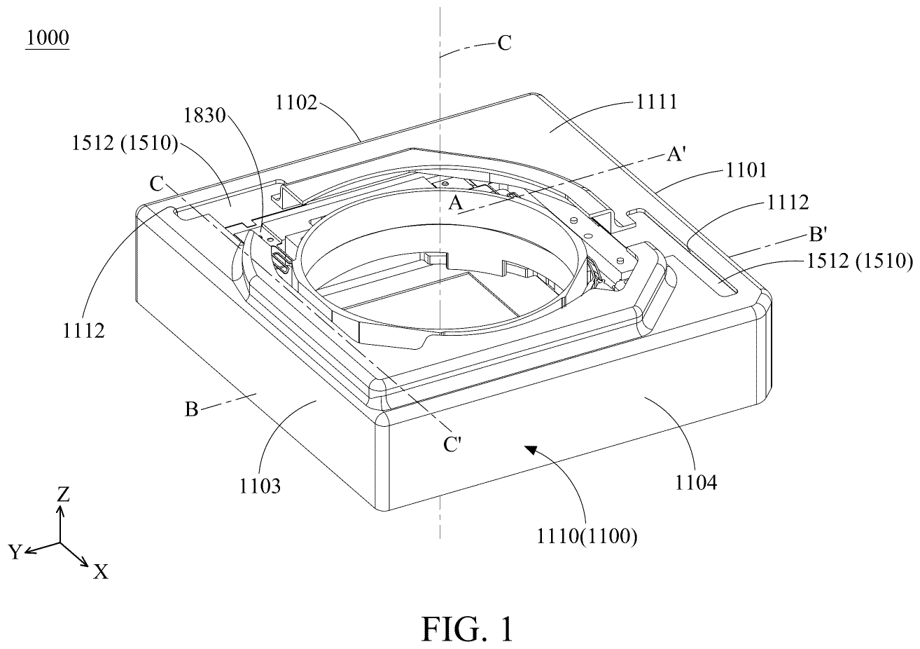

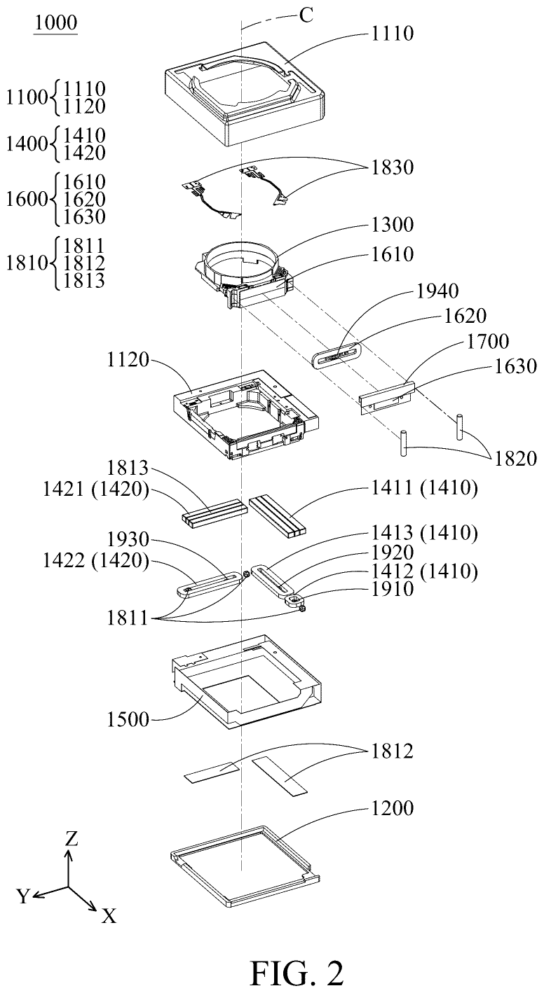

FIG. 1 is a perspective view of an optical element driving mechanism 1000 according to some embodiments of the present disclosure. FIG. 2 is an exploded view of the optical element driving mechanism 1000 according to some embodiments of the present disclosure. Please refer to FIG. 1 and FIG. 2 below.

As shown in FIG. 1 and FIG. 2, the optical element driving mechanism 1000 includes a fixed portion 1100, a first movable portion 1200, a second movable portion 1300, a first driving component 1400, and a first circuit member 1500, a second driving component 1600, a second circuit member 1700, a first support component 1810, a second support component 1820, a third support component 1830 and four sensing elements 1910, 1920, 1930, 1940.

As shown in FIG. 1, according to some embodiments of the present disclosure, the fixed portion 1100 has a main axis C, a first side 1101, a second side 1102, a third side 1103 and a fourth side. 1104. The main axis C may be regarded as a geometric center axis passing through the optical element driving mechanism 1000.

According to some embodiments of the present disclosure, the first side 1101 is adjacent to the second side 1102. The third side 1103 is adjacent to the fourth side 1104. The first side 1101 and the third side 1103 are two opposite sides of the fixed portion 1100. The second side 1102 and the fourth side 1104 are two opposite sides of the fixed portion 1100.

As shown in FIG. 2, according to some embodiments of the present disclosure, the fixed portion 1100 includes a housing 1110 and a frame 1120. The housing 1110 is fixedly connected to the frame 1120 to form a space for accommodating other components of the optical element driving mechanism 1000.

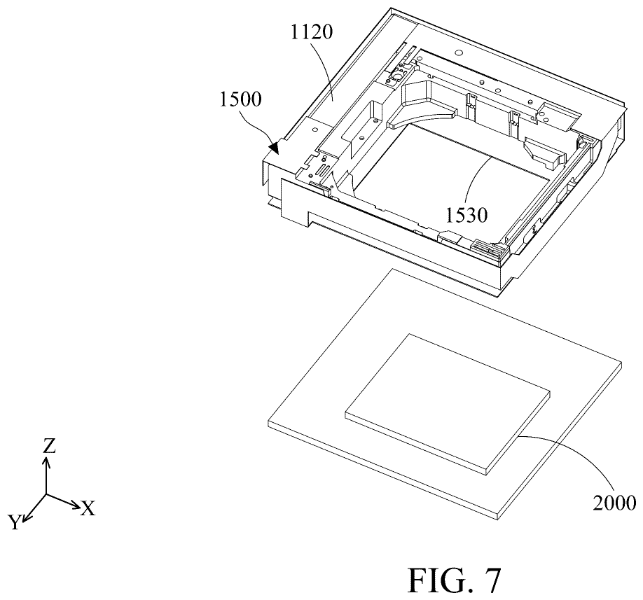

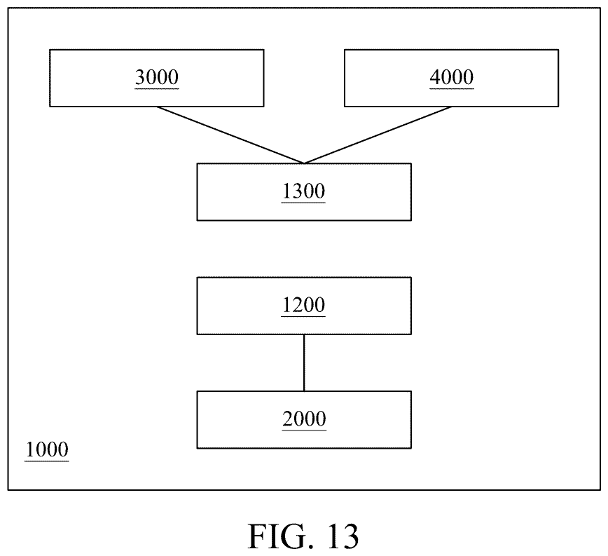

According to some embodiments of the present disclosure, the first movable portion 1200 is configured to connect the first optical element 2000 (FIG. 7, FIG. 13). In this embodiment, the first optical element 2000 is an image sensor. The first movable portion 1200 may rotate and translate relative to the fixed portion 1100 to achieve the optical effect of optical image stabilization (OIS).

According to some embodiments of the present disclosure, the second movable portion 1300 is configured to connect the second optical element 3000 (FIG. 13). In this embodiment, the second optical element 3000 is a lens assembly. The second movable portion 1300 is movable on the Z-axis relative to the fixed portion 1100 to achieve the optical effect of auto focus (AF).

According to some embodiments of the present disclosure, the first driving component 1400 is configured to drive the first movable portion 1200 to move relative to the fixed portion 1100. The first driving component 1400 includes a first driving portion 1410 and a second driving portion 1420. The first circuit member 1500 movably connects the first movable portion 1200 to the frame 1120 of the fixed portion 1100. The first circuit member 1500 corresponds to the first optical element 2000 (FIG. 7).

As shown in FIG. 2, the first driving portion 1410 includes a first magnetic element 1411, a first coil 1412 and a second coil 1413. The second driving portion 1420 includes a second magnetic element 1421 and a third coil 1422.

According to some embodiments of the present disclosure, the first magnetic element 1411 and the second magnetic element 1421 are disposed on the frame 1120 of the fixed portion 1100. The first coil 1412, the second coil 1413 and the third coil 1422 are disposed on the first circuit member 1500. The first coil 1412, the second coil 1413 and the third coil 1422 are each independently controlled.

In this way, when a driving signal is applied to the first driving component 1400 (for example, a current is applied by an external power supply), the first driving portion 1410 and the second driving portion 1420 respectively generate electromagnetic induction forces to drive the first movable portion 1200 to move relative to the fixed portion 1100 to achieve the required optical effect.

For example, the electromagnetic induction force generated between the first coil 1412, the second coil 1413 and the first magnetic element 1411 and between the third coil 1422 and the second magnetic element 1421 may drive the first movable portion 1200 to rotate counterclockwise or clockwise relative to the fixed portion 1100.

Alternatively, the electromagnetic induction force generated between the second coil 1413 and the first magnetic element 1411 and between the third coil 1422 and the second magnetic element 1421 may drive the first movable portion 1200 to translate in the XY plane relative to the fixed portion 1100.

According to some embodiments of the present disclosure, the second driving component 1600 is configured to drive the second movable portion 1300 to move relative to the fixed portion 1100. The second driving component 1600 includes a magnetic element 1610, a coil 1620 and a magnetically permeable element 1630. The magnetic element 1610 is provided on the second movable portion 1300. The coil 1620 and the magnetically permeable element 1630 are disposed on two opposite surfaces of the second circuit member 1700.

In this way, when a driving signal is applied to the second driving component 1600 (for example, a current is applied by an external power supply), an electromagnetic induction force is generated between the coil 1620 and the magnetic element 1610, and the second movable portion 1300 is driven to move in the Z-axis direction relative to the fixed portion 1100 to achieve the required optical effect.

According to some embodiments of the present disclosure, the second circuit member 1700 is provided on the frame 1120 of the fixed portion 1100. The coil 1620 is electrically connected to the second circuit member 1700.

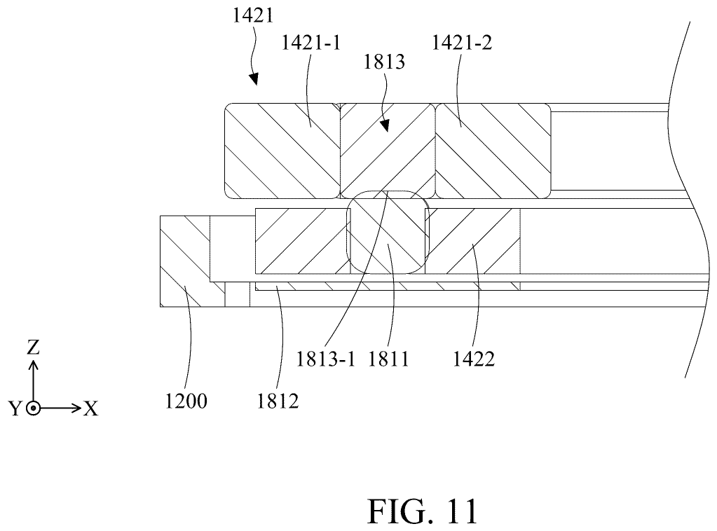

According to some embodiments of the present disclosure, the first support component 1810 supports the first movable portion 1200 to move relative to the fixed portion 1100. That is to say, the first movable portion 1200 is movable relative to the fixed portion 1100 via the support of the first support component 1810. The first support component 1810 includes an intermediate element 1811, a force-exerting element 1812 and a corresponding element 1813, the details of which is described in detail later with reference to FIG. 11.

According to some embodiments of the present disclosure, the second support component 1820 supports the second movable portion 1300 to move relative to the fixed portion 1100. In this embodiment, the second support component 1820 may be a pair of guide rods. The second support component 1820 is disposed on a side of the frame 1120 corresponding to the magnetic element 1610.

In this way, an attractive force is generated between the magnetic element 1610 disposed on the second movable portion 1300 and the magnetically permeable element 1630 disposed on the frame 1120 (the magnetically permeable element 1630 is indirectly disposed on the frame 1120 through the second circuit member 1700), causing the second movable portion 1300 to lean towards the direction of the second support component 1820. This makes the movement of the second movable portion 1300 relative to the fixed portion 1100 smoother, reducing the likelihood of shaking, toppling, and other issues, thereby improving the precision of auto focus. According to some embodiments of this disclosure, the third support component 1830 is a spring plate movably connecting the frame 1120 and the second movable portion 1300.

According to some embodiments of the present disclosure, the sensing elements 1910, 1920, and 1930 are all disposed on the first circuit member 1500, wherein the sensing element 1910 is positioned in the hollow part of the annular structure of the first coil 1412, the sensing element 1920 is positioned in the hollow part of the annular structure of the second coil 1413, and the sensing element 1930 is positioned in the hollow part of the annular structure of the third coil 1422.

According to some embodiments of the present disclosure, the sensing elements 1910, 1920 correspond to the first magnetic element 1411. The sensing element 1930 corresponds to the second magnetic element 1421. In detail, the sensing elements 1910 and 1920 may sense changes in the magnetic field of the first magnetic element 1411, and the sensing element 1930 may sense changes in the magnetic field of the second magnetic element 1421, and the position of the first movable portion 1200 relative to the fixed portion 1100 is determined through a control element (not shown).

According to some embodiments of the present disclosure, the sensing element 1910 may sense the rotational movement of the first movable portion 1200 relative to the fixed portion 1100. The sensing elements 1920 and 1930 may sense the translational movement of the first movable portion 1200 relative to the fixed portion 1100 in the XY plane.

According to some embodiments of the present disclosure, the sensing element 1940 is disposed on the second circuit member 1700, wherein the sensing element 1940 is positioned in a hollow position of the annular structure of the coil 1620. The sensing element 1940 may be an all-in-one integrated circuit (All-in-one IC) that encapsulates the sensing integrated circuit and the control integrated circuit within the same package. This allows the sensing element 1940 to determine the position of the second movable portion 1300 by sensing changes in the magnetic field of the magnetic element 1610, and then control the second movable portion 1300 to move to the desired position, achieving closed-loop control.

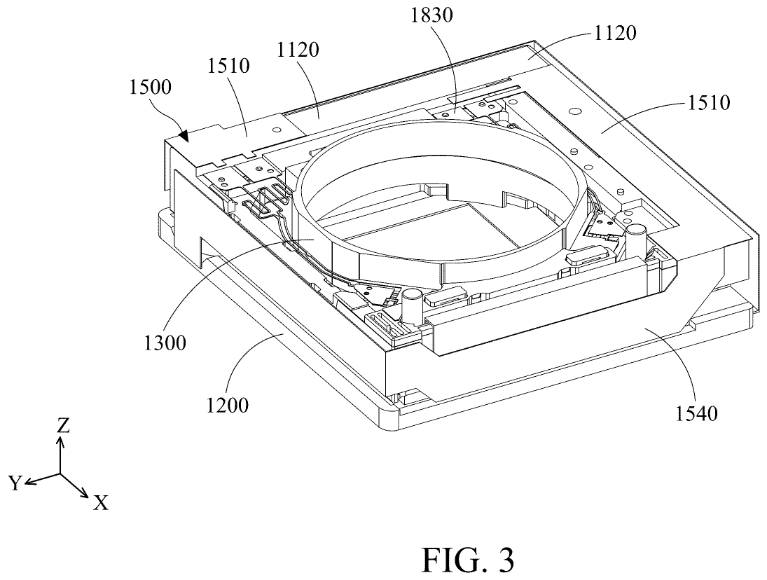

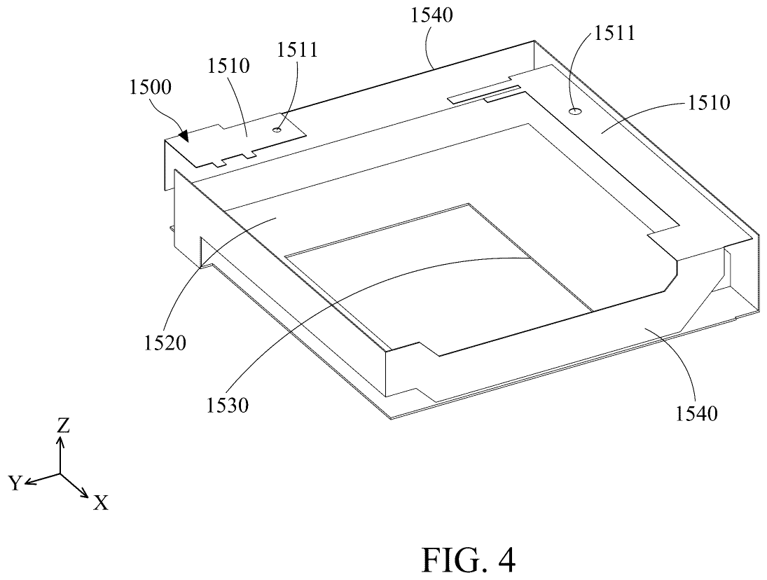

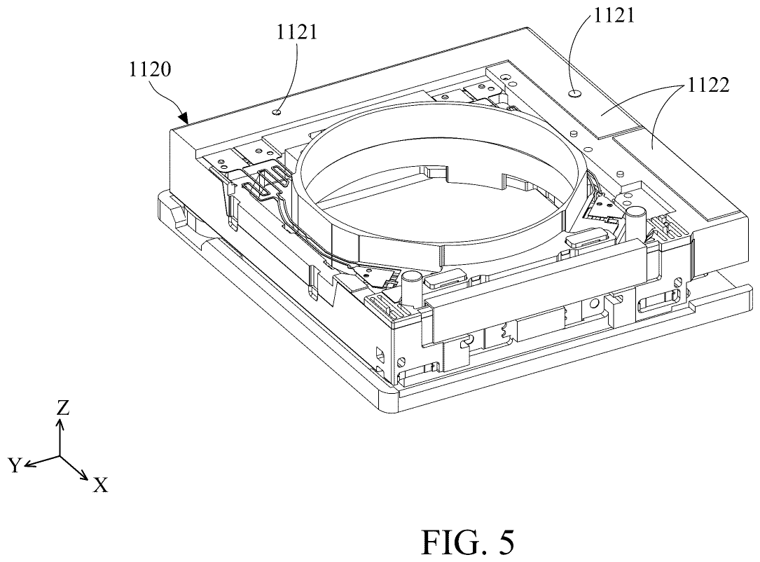

FIG. 3 is a perspective view of the optical element driving mechanism 1000 without showing the housing 1110. FIG. 4 is a perspective view of a part of the first circuit member 1500 according to some embodiments of the disclosure. FIG. 5 is a perspective view of a part of the optical element driving mechanism 1000 according to some embodiments of the disclosure. Please refer to FIG. 3 to FIG. 5 below.

As shown in FIGS. 3 to 5, the frame 1120 includes a first support portion 1121 and a second support portion 1122. The first circuit member 1500 includes two first circuit portions 1510, a second circuit portion 1520, an opening 1530 and two flexible portions 1540.

According to some embodiments of the present disclosure, the first circuit member 1500 is configured to electrically connect an external circuit (not shown). The first circuit portion 1510 is a part of the first circuit member 1500 that is disposed on the second support portion 1122 of the frame 1120.

Each of the two first circuit portions 1510 includes an opening 1511 and an output circuit 1512 (FIG. 1). The first support portion 1121 protrudes from the second support portion 1122 and passes through the opening 1511 of the first circuit portion 1510 to position the first circuit portion 1510 on the second support portion 1122.

According to some embodiments of the present disclosure, the second circuit portion 1520 of the first circuit member 1500 is connected to the first movable portion 1200. The second circuit portion 1520 is parallel to the first circuit portion 1510. The opening 1530 of the first circuit member 1500 is positioned on the second circuit portion 1520 and corresponds to the first optical element 2000 (FIG. 7).

According to some embodiments of the present disclosure, two ends of the flexible portion 1540 of the first circuit member 1500 are movably connected to the first circuit portion 1510 and the second circuit portion 1520 respectively, so that the first movable portion 1200 is movable relative to the frame 1120. The flexible portion 1540 is not parallel to the first circuit portion 1510 and the second circuit portion 1520.

Please refer back to FIG. 1 for now. The housing 1110 includes a top surface 1111. The top surface 1111 includes two external ports 1112. The top surface 1111 may be made of metal material. The output circuit 1512 of the first circuit portion 1510 can also be seen in FIG. 1. When viewed along the direction of negative Z-axis, the output circuit 1512 is at least partially exposed from the external port 1112 of the top surface 1111.

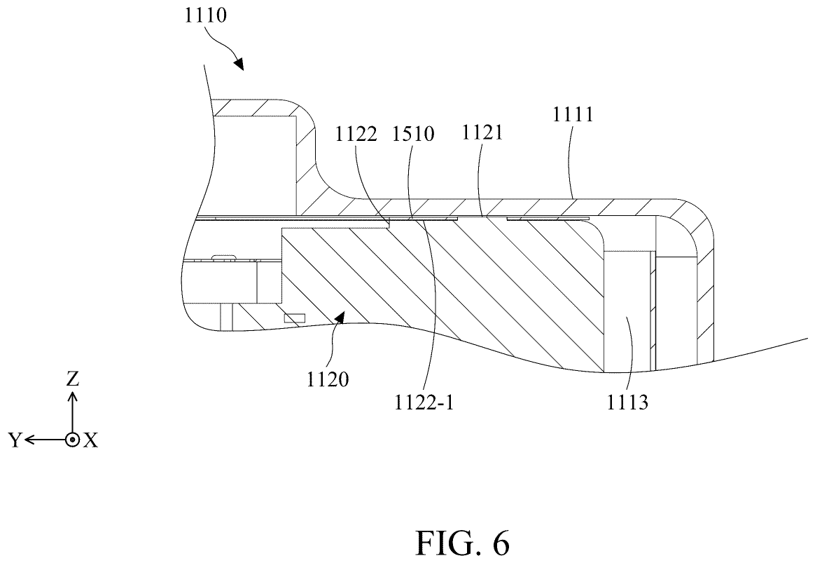

FIG. 6 shows a partial cross-sectional view of the optical element driving mechanism 1000 taken along line A-A′ of FIG. 1. As shown in FIG. 6, the housing 1110 also includes an accommodating space 1113. The frame 1120 is disposed in the accommodating space 1113 of the housing 1110. The second support portion includes frame surface 1122-1. The frame surface 1122-1 faces the top surface 1111 of the housing 1110.

According to some embodiments of the present disclosure, the frame 1120 may be made of materials such as resin. As shown in FIG. 6, the first circuit portion 1510 has a plate-like structure. The first circuit portion 1510 is at least partially located between the housing 1110 and the frame 1120. The first support portion 1121 of the frame 1120 directly contacts the top surface 1111 of the housing 1110.

As shown in FIG. 6, the first support portion 1121 of the frame 1120 protrudes from the frame surface 1122-1. The second support portion 1122 of the frame 1120 corresponds to the first circuit portion 1510. The shortest distance between the first support portion 1121 and the top surface 1111 is less than the shortest distance between the second support portion 1122 and the top surface 1111.

As shown in FIG. 6, since the first support portion 1121 passes through the opening 1511 of the first circuit portion 1510 (FIG. 4), when viewed along the direction that is parallel to the frame surface 1122-1 (e.g., in the direction of the X-axis), the first circuit portion 1510 overlaps at least partially with the first support portion 1121.

As shown in FIG. 6, since the first circuit portion 1510 is disposed on the second support portion 1122, when viewed along the direction parallel to the frame surface 1122-1 (for example, the direction of the X-axis), the first circuit portion 1510 is disposed on the second support portion 1122. The circuit portion 1510 and the second support portion 1122 do not overlap.

As shown in FIG. 6, since the second support portion 1122 is designed to provide support when the first circuit portion 1510 is soldered, the shortest distance between the first circuit portion 1510 and the top surface 1111 is different from the shortest distance between the first circuit portion 1510 and the second support portion 1122. In detail, the shortest distance between the first circuit portion 1510 and the top surface 1111 is greater than the shortest distance between the first circuit portion 1510 and the second support portion 1122.

Please briefly refer to FIG. 1 and FIG. 5 together. When viewed along the direction perpendicular to the frame surface 1122-1 in FIG. 6 (for example, the direction of the negative Z-axis), the second support portion 1122 at least partially overlap with the external port 1112 of the housing 1110.

FIG. 7 shows an exploded schematic diagram of the first optical element 2000 corresponding to the opening 1530 of the first circuit member 1500. As shown in FIG. 7, the geometry of the first optical element 2000 corresponds to the geometry of the opening 1530 of the first circuit member 1500.

As shown in FIG. 7, when viewed along the main axis C (the Z-axis), the opening 1530 of the first circuit member 1500 and the first optical element 2000 both have polygonal structures. To be specific, the opening 1530 of the first circuit member 1500 and the first optical element 2000 are both quadrilateral structures in this embodiment.

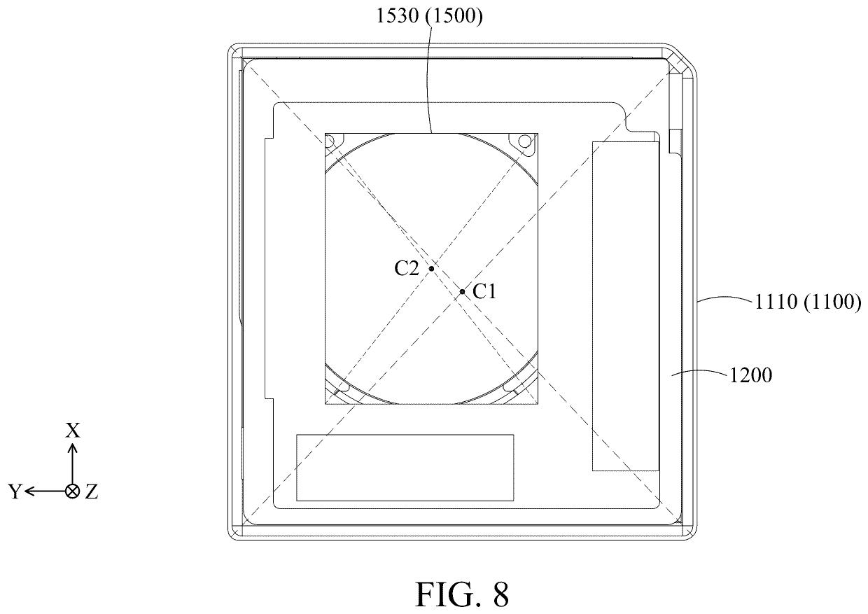

FIG. 8 shows a bottom view of the optical element driving mechanism 1000 according to some embodiments of the present disclosure. As shown in FIG. 7, since the geometry of the first optical element 2000 corresponds to the geometry of the opening 1530 of the first circuit member 1500, the geometry of the opening 1530 can be regarded as the geometry of the first optical element 2000 (FIG. 7).

As shown in FIG. 8, when viewed along the main axis C (FIG. 1), the geometric center C1 of the fixed portion 1100 does not overlap with the geometric center C2 of the opening 1530 of the first circuit member 1500. Since the geometry of the first optical element 2000 (FIG. 7) corresponds to the geometry of the opening 1530 of the first circuit member 1500, it can be understood that when viewed along the main axis C (FIG. 1), the geometric center of the fixed portion 1100 does not overlap with the geometric center of the first optical element 2000.

As shown in FIG. 8, when viewed along the main axis C (FIG. 1), the geometric center of the fixed portion 1100 and the geometric center of the first movable portion 1200 are both generally located at the position of the geometric center C1. When viewed along the main axis C (FIG. 1), the geometric center C2 of the opening 1530 does not overlap with the geometric center C1 of the first movable portion 1200.

Since the geometry of the first optical element 2000 (FIG. 7) corresponds to the geometry of the opening 1530 of the first circuit member 1500, it can be understood that when viewed along the main axis C (FIG. 1), the geometric center C1 of the first movable portion 1200 does not overlap with the geometric center of the first optical element 2000.

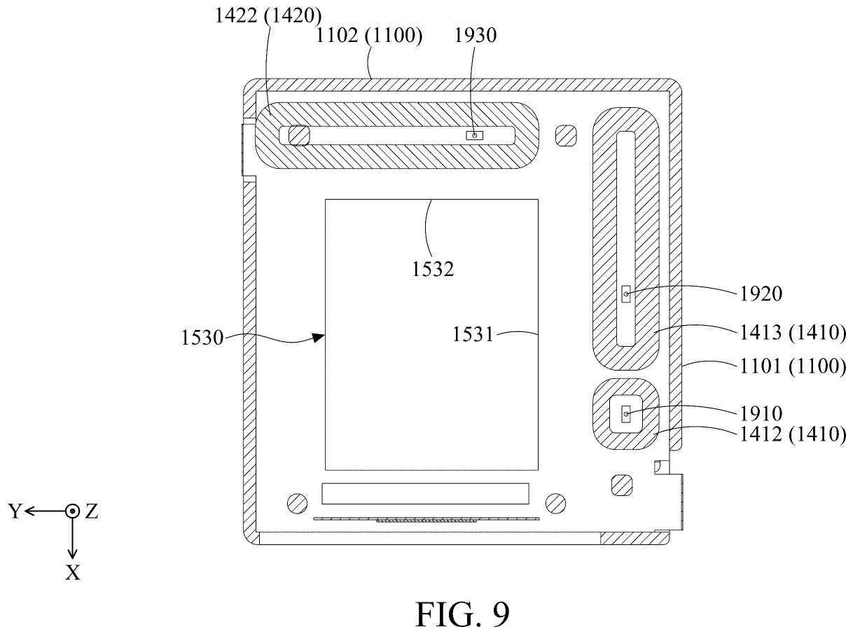

FIG. 9 is a cross-sectional view of the optical element driving mechanism 1000 taken along line B-B′ in FIG. 1. FIG. As shown in FIG. 9, the opening 1530 includes a first boundary 1531 and a second boundary 1532. When viewed along the main axis C (the Z-axis), the length of the first boundary 1531 is greater than the length of the second boundary 1532.

As shown in FIG. 9, when viewed along the main axis C (the Z-axis), the first boundary 1531 is adjacent to the first side 1101 of the fixed portion 1100. When viewed along the main axis C, the second boundary 1532 is adjacent to the second side 1102 of the fixed portion 1100.

As shown in FIG. 9, when viewed along the main axis C (the Z-axis), the first coil 1412 and the second coil 1413 of the first driving portion 1410 are located on the first side 1101. When viewed along the main axis C, the second driving portion 1420 is located on the second side 1102. When viewed along the main axis C, the shortest distance between the first boundary 1531 and the first side 1101 is different from the shortest distance between the second boundary 1532 and the second side 1102.

As shown in FIG. 9, when viewed along the main axis C (the Z-axis), the maximum size of the first coil 1412 is different from the maximum size of the second coil 1413 in the extending direction of the first side 1101 (the direction of the X-axis). In detail, when viewed along the main axis C, the maximum size of the first coil 1412 is smaller than the maximum size of the second coil 1413 in the extending direction of the first side 1101.

As shown in FIG. 9, the third coil 1422 is located on the second side 1102 when viewed along the main axis C (the Z-axis). When viewed along the main axis C, the shortest distance between the first coil 1412 and the third coil 1422 is different from the shortest distance between the second coil 1413 and the third coil 1422. When viewed along the main axis C, the shortest distance between the first coil 1412 and the third coil 1422 is greater than the shortest distance between the second coil 1413 and the third coil 1422.

As shown in FIG. 9, when viewed along the main axis C, the first boundary 1531 and the first side 1101 are parallel to each other, and the second boundary 1532 and the second side 1102 are parallel to each other. When viewed along the main axis C, the shortest distance between the first boundary 1531 and the first side 1101 is greater than the shortest distance between the second boundary 1532 and the second side 1102.

In this way, although the first coil 1412 and the second coil 1413 on the same side generate more heat at the first side 1101, their distance from the first optical element 2000 (FIG. 7) along the Y-axis reduces the thermal impact on the first optical element 2000 (FIG. 7), while also aiding in the heat dissipation of the first optical element 2000 (FIG. 7).

Furthermore, although the first coil 1412 and the second coil 1413 on the same side generate more interference at the first side 1101, their greater distance from the first optical element 2000 (FIG. 7) along the Y-axis effectively improves signal interference issues.

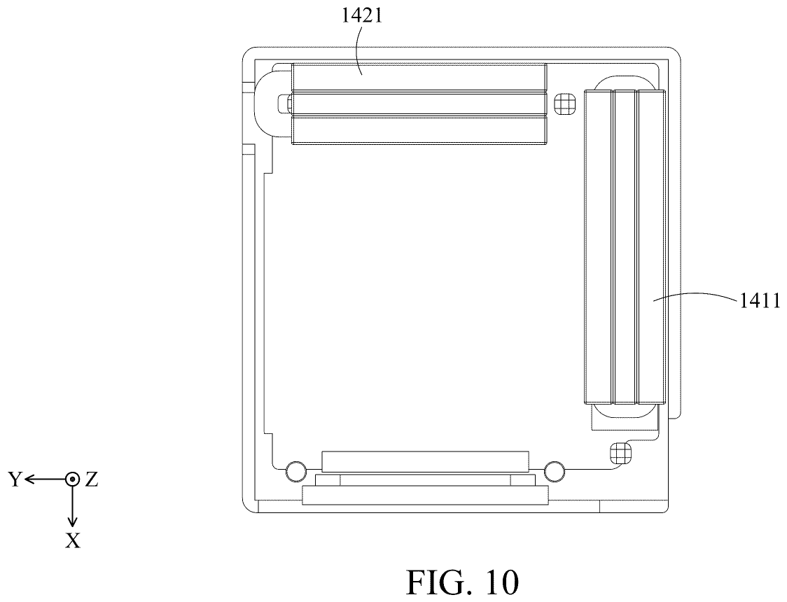

FIG. 10 shows a top view of a part of the optical element driving mechanism 1000 according to some embodiments of the present disclosure. The area of the first magnetic element 1411 is different from the area of the second magnetic element 1421 when viewed along the main axis C (the Z-axis). When viewed along the main axis C, the area of the first magnetic element 1411 is larger than the area of the second magnetic element 1421.

FIG. 11 is a cross-sectional view of the optical element driving mechanism 1000 taken along line C-C′ in FIG. 1. As shown in FIG. 11, the intermediate element 1811 may be a ball. The force-exerting element 1812 may be a magnetically permeable element made of magnetically permeable material (for example, an alloy including iron, nickel, etc.). The force-exerting element 1812 corresponds to the second magnetic element 1421 to generate a first stabilizing force. The force-exerting element 1812 is configured to apply a first stabilizing force to the first movable portion 1200 so that the intermediate element 1811 contacts the corresponding element 1813.

As shown in FIG. 11, the second magnetic element 1421 includes a first magnetic portion 1421-1 and a second magnetic portion 1421-2. The corresponding element 1813 is provided on the first magnetic portion 1421-1. When viewed along the main axis C (FIG. 1) or the Y-axis, the corresponding element 1813 is located between the first magnetic portion 1421-1 and the second magnetic portion 1421-2.

According to some embodiments of the present disclosure, due to the need for a non-magnetic zone between the first magnetic portion 1421-1 and the second magnetic portion 1421-2, a corresponding element 1813 is placed between the first magnetic portion 1421-1 and the second magnetic portion 1421-2. The corresponding element 1813 may be made of metal. The corresponding element 1813 corresponds to the intermediate element 1811 and is movable relative to the intermediate element 1811.

Furthermore, since the length of the first magnetic portion 1421-1 and the second magnetic portion 1421-2 being too long may lead to easy breakage, placing the corresponding element 1813 between them strengthens the overall structure of the second magnetic element 1421.

As shown in FIG. 11, the third coil 1422 is located between the force-exerting element 1812 and the second magnetic element 1421. When viewed along the main axis C (the Z-axis), the intermediate element 1811 at least partially overlaps the space surrounded by the third coil 1422. The intermediate element 1811 at least partially overlaps the third coil 1422 when viewed along a direction perpendicular to the main axis (e.g., the X-axis). As shown in FIG. 11, the corresponding element 1813 includes a corresponding surface 1813-1. The corresponding surface 1813-1 faces the intermediate element 1811.

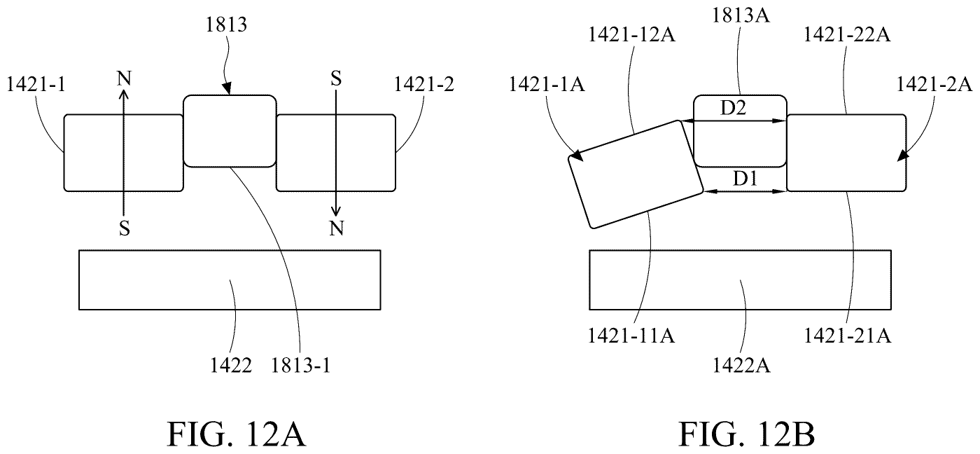

FIG. 12A shows a schematic side view of the second driving portion 1420 and the corresponding element 1813 according to an embodiment of the present disclosure. As shown in FIG. 12A, the direction of the magnetic pole alignment of the first magnetic portion 1421-1 is opposite to the direction of the magnetic pole alignment of the second magnetic portion 1421-2. It should be understood that the direction of the magnetic pole alignment described herein is defined as the direction in which the S pole faces towards the N pole.

As shown in FIG. 12A, the corresponding surface 1813-1 is not parallel to the direction of the magnetic pole alignment of the first magnetic portion 1421-1. Although not clearly shown in FIG. 11, it should be understood that the maximum size of the first magnetic portion 1421-1 is different from the maximum size of the corresponding element 1813 in the direction of the magnetic pole alignment of the first magnetic portion 1421-1. Specifically, as shown in FIG. 12A, the maximum size of the first magnetic portion 1421-1 is larger than the maximum size of the corresponding element 1813 in the direction of the magnetic pole alignment of the first magnetic portion 1421-1.

FIG. 12B shows a schematic side view of the second driving portion 1420A and the corresponding element 1813A according to another embodiment of the present disclosure. As shown in FIG. 12B, the first magnetic portion 1421-1A includes a first magnetic surface 1421-11A and a second magnetic surface 1421-12A. The first magnetic surface 1421-11A faces the third coil 1422A, and the second magnetic surface 1421-12A faces the opposite direction to the first magnetic surface 1421-11A.

As shown in FIG. 12B, the second magnetic portion 1421-2A includes a third magnetic surface 1421-21A and a fourth magnetic surface 1421-22A. The third magnetic surface 1421-21A faces the third coil 1422A, and the fourth magnetic surface 1421-22A and the third magnetic surface 1421-21A face in opposite directions.

In the embodiment shown in FIG. 12B, the shortest distance D1 between the first magnetic surface 1421-11A and the third magnetic surface 1421-21A is different from the shortest distance D2 between the second magnetic surface 1421-12A and the fourth magnetic surface 1421-22A. In detail, the shortest distance D1 between the first magnetic surface 1421-11A and the third magnetic surface 1421-21A is less than the shortest distance D2 between the second magnetic surface 1421-12A and the fourth magnetic surface 1421-22A.

FIG. 13 shows a block diagram of the optical element driving mechanism 1000 according to some embodiments of the present disclosure. As shown in FIG. 13, the first movable portion 1200 is connected to the first optical element 2000. The second movable portion 1300 is connected to the second optical element 3000, and an optical module 4000 serving as an aperture module is installed on the second movable portion 1300 to control the amount of light entering the optical element driving mechanism 1000.

Please refer briefly to FIG. 1. In the embodiment shown in FIG. 1, the optical element driving mechanism 1000 further includes a third circuit member (not shown), which is configured to electrically connect with the optical module 4000 (FIG. 13). In this embodiment, the optical module 4000 is electrically connected to the output circuit 1512 of the first circuit portion 1510 via this third circuit member from above the housing 1110 through the external interface 1112. Therefore, it can be understood that when viewed along a direction that is perpendicular to the main axis C (e.g., the X-axis or Y-axis), the top surface 1111 of the housing 1110 will be at least partially located between the first circuit portion 1510 and the aforementioned third circuit member.

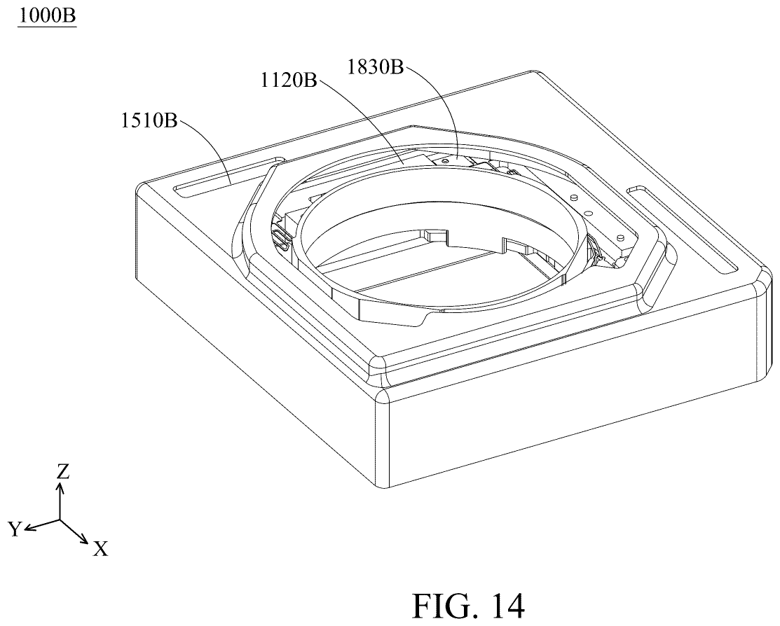

FIG. 14 is a perspective view of the optical element driving mechanism 1000B according to another embodiment of the present disclosure. In the embodiment shown in FIG. 14, the third support member 1830B serves as a third circuit member for electrically connecting to the optical module 4000 (FIG. 13). As shown in FIG. 14, when viewed along a direction that is perpendicular to the main axis (e.g., the X-axis or Y-axis), the third support component 1830B (third circuit member) is at least partially located between the first circuit portion 1510B and the frame 1120B.

In summary, the driving component of the present invention adopts an asymmetrical arrangement, with the image sensor eccentrically positioned relative to the fixed portion. This design allows the driving component of the present invention to enable the movable portion to move relative to the fixed portion with greater driving force. Although the two coils (the first coil and the second coil) of the first driving portion are located on the same side and generate more heat, their distance from the eccentrically positioned image sensor reduces the thermal impact on the image sensor and also aids in its heat dissipation. Furthermore, while the two coils generate more signal interference due to electromagnetic fields, the greater distance from the image sensor effectively mitigates the signal interference issues. Additionally, the eccentric design of the image sensor allows for more efficient use of the internal space of electronic devices such as mobile phones, thereby increasing the screen-to-body ratio and resulting in a larger display area, providing a better visual experience.

Although the embodiments and their advantages of the present invention have been disclosed above, it should be understood that any modification and substitution can be made by anyone with ordinary skill in the art without departing from the spirit and scope of the present disclosure. In addition, each claim constitutes an individual embodiment, and the protection scope of the present disclosure also includes the combination of each claim and embodiments.

What is claimed is:

1. An optical element driving mechanism, comprising:
a first movable portion for connecting a first optical element;
a fixed portion having a main axis, wherein the first movable portion is movable relative to the fixed portion; and
a first driving component configured to drive the first movable portion to move relative to the fixed portion.

2. The optical element driving mechanism as claimed in claim 1, wherein a geometric center of the fixed portion does not overlap with a geometric center of the first optical element when viewed along the main axis; the first optical element has a polygonal structure when viewed along the main axis; a geometric center of the first movable portion does not overlap with the geometric center of the first optical element when viewed along the main axis.

3. The optical element driving mechanism as claimed in claim 2, further comprising a first circuit member, the first circuit member comprises an opening corresponding to the first optical element, wherein the opening has a polygonal structure when viewed along the main axis, and a geometric center of the opening does not overlap with the geometric center of the first movable portion.

4. The optical element driving mechanism as claimed in claim 3, wherein the opening comprises a first boundary and a second boundary, and the length of the first boundary is greater than the length of the second boundary when viewed along the main axis.

5. The optical element driving mechanism as claimed in claim 4, wherein the fixed portion has a first side and a second side; the first boundary is adjacent to the first side of the fixed portion when viewed along the main axis; the second boundary is adjacent to the second side of the fixed portion when viewed along the main axis.

6. The optical element driving mechanism as claimed in claim 5, wherein the first driving component comprises a first driving portion and a second driving portion, and the first driving portion is located on the first side when viewed along the main axis; the second driving portion is located on the second side when viewed along the main axis; the shortest distance between the first boundary and the first side is different from the shortest distance between the second boundary and the second side when viewed along the main axis; the first boundary and the first side are parallel to each other, and the second boundary and the second side are parallel to each other when viewed along the main axis; the shortest distance between the first boundary and the first side is greater than the shortest distance between the second boundary and the second side when viewed along the main axis.

7. The optical element driving mechanism as claimed in claim 6, wherein the first driving portion comprises a first magnetic element, a first coil and a second coil, the second driving portion comprises a second magnetic element and a third coil; the area of the first magnetic element is different from the area of the second magnetic element when viewed along the main axis; the area of the first magnetic element is greater than the area of the second magnetic element when viewed along the main axis; the first coil and the second coil are located on the first side when viewed along the main axis; when viewed along the main axis, the maximum size of the first coil is different from the maximum size of the second coil in the extending direction of the first side.

8. The optical element driving mechanism as claimed in claim 7, wherein when viewed along the main axis, the maximum size of the first coil is smaller than the maximum size of the second coil in the extending direction of the first side; the third coil is located on the second side when viewed along the main axis; the shortest distance between the first coil and the third coil is different from the shortest distance between the second coil and the third coil when viewed along the main axis; the shortest distance between the first coil and the third coil is greater than the shortest distance between the second coil and the third coil when viewed along the main axis.

9. The optical element driving mechanism as claimed in claim 7, further comprising a first support component, wherein the first movable portion is movable relative to the fixed portion via the first support component, the first support component comprises:
an intermediate element;
a corresponding element corresponding to the intermediate element and movable relative to the intermediate element; and
a force-exerting element configured to apply a first stabilizing force to the first movable portion to make the intermediate element contact the corresponding element.

10. The optical element driving mechanism as claimed in claim 9, wherein the force-exerting element corresponds to the second magnetic element to generate the first stabilizing force, the force-exerting element has a magnetically permeable material, and the third coil is located between the force-exerting element and the second magnetic element; the intermediate element at least partially overlaps the space surrounded by the third coil when viewed along the main axis; the intermediate element at least partially overlaps the third coil when viewed along the direction perpendicular to the main axis.

11. The optical element driving mechanism as claimed in claim 9, wherein the second magnetic element comprises a first magnetic portion and a second magnetic portion, and the corresponding element is disposed on the first magnetic portion; the corresponding element has a metal material; the corresponding element is located between the first magnetic portion and the second magnetic portion when viewed along the main axis; the direction of the magnetic pole alignment of the first magnetic portion is opposite to the direction of the magnetic pole alignment of the second magnetic portion.

12. The optical element driving mechanism as claimed in claim 11, wherein a corresponding surface of the corresponding element faces the intermediate element, and the corresponding surface is not parallel to the direction of the magnetic pole alignment of the first magnetic portion; in the direction of the magnetic pole alignment of the first magnetic portion, the maximum size of the first magnetic portion is different from the maximum size of the corresponding element.

13. The optical element driving mechanism as claimed in claim 11, wherein in the direction of the magnetic pole alignment of the first magnetic portion, the maximum size of the first magnetic portion is larger than the maximum size of the corresponding element.

14. The optical element driving mechanism as claimed in claim 11, wherein the first magnetic portion comprises a first magnetic surface and a second magnetic surface, the first magnetic surface faces the third coil, and the second magnetic surface and the first magnetic surface face opposite directions.

15. The optical element driving mechanism as claimed in claim 14, wherein the second magnetic portion comprises a third magnetic surface and a fourth magnetic surface, the third magnetic surface faces the third coil, and the fourth magnetic surface and the third magnetic surface face opposite directions.

16. The optical element driving mechanism as claimed in claim 15, wherein the shortest distance between the first magnetic surface and the third magnetic surface is different from the shortest distance between the second magnetic surface and the fourth magnetic surface, and the shortest distance between the first magnetic surface and the third magnetic surface is smaller than the shortest distance between the second magnetic surface and the fourth magnetic surface.

17. The optical element driving mechanism as claimed in claim 1, further comprising a first circuit member for electrically connecting an external circuit, the first circuit member comprising a first circuit portion, the first circuit portion comprises an output circuit, wherein the fixed portion comprises:
a housing having a top surface and an accommodating space, the top surface comprises an external port, and the top surface has a metal material; and
a frame disposed in the accommodating space of the housing, the frame comprises a frame surface, a first support portion and a second support portion;
wherein the first circuit portion is at least partially located between the housing and the frame, the output circuit is at least partially exposed on the external port of the top surface, the first circuit portion has a plate-like structure, the frame has a resin material, and the frame surface of the frame faces the top surface of the housing, the first support portion of the frame directly contacts the top surface, the first support portion protrudes from the frame surface, and the second support portion of the frame corresponds to the first circuit portion.

18. The optical element driving mechanism as claimed in claim 17, wherein the shortest distance between the first support portion and the top surface is less than the shortest distance between the second support portion and the top surface; the first circuit portion and the first support portion at least partially overlap when viewed in a direction parallel to the frame surface; the first circuit portion and the second support portion do not overlap when viewed in a direction parallel to the frame surface; the second support portion and the external port at least partially overlap when viewed along the direction perpendicular to the frame surface; the shortest distance between the first circuit portion and the top surface is different from the shortest distance between the first circuit portion and the second support portion; the shortest distance between the first circuit portion and the top surface is greater than the shortest distance between the first circuit portion and the second support portion.

19. The optical element driving mechanism as claimed in claim 17, further comprising a second movable portion, a second circuit member and a third circuit member, the second circuit member is disposed on the second movable portion, the third circuit member is movably connected to the frame and the second movable portion, the third circuit member is configured to electrically connect with an optical module, the third circuit member is at least partially located between the first circuit portion and the frame.

20. The optical element driving mechanism as claimed in claim 17, further comprising a second movable portion, a second circuit member and a third circuit member, the second circuit member is disposed on the second movable portion, the third circuit member is configured to electrically connect with an optical module, and the top surface is at least partially located between the first circuit portion and the third circuit member.
